(19) United States
(12) Patent Application Publication
(10) Pub. No.: US 2010/0098511 A1
(43) Pub. Date: Apr. 22, 2010

(54) LOCKING SYSTEM AND FASTENING ELEMENTS

(75) Inventor: Mattias Andersson, Ostersund (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: NORD-LOCK AB, Mattmar (SE)

(21) Appl. No.: 12/438,825

(22) PCT Filed: Aug. 28, 2007
(86) PCT No.: PCT/SE07/50584

§ 371 Date: Oct. 21, 2009

(30) Foreign Application Priority Data
Sep. 1, 2006 (SE) 0601801-4

(51) Int. Cl. F16B 39/24; F16B 37/00; F16B 33/00

(52) U.S. Cl. 411/149; 411/427; 411/378

(57) ABSTRACT

A locking system comprising a fastening element, the fastening element being a hexagonal nut or a hexagon-headed bolt, and a locking washer unit, a locking washer having a central hole, a first side comprising a pattern of radially extending teeth and a second side comprising a pattern of radially extending cams. The system is especially characterized in that the fastening element comprises a contact portion extending from the hexagonal part of the fastening element and providing an annular end surface of the hexagonal fastening element part, the contact portion having an outer diameter (D) substantially corresponding to the maximum width (w) of the hexagonal fastening element part. The invention also. relates to a fastening element.

### TECHNICAL FIELD

The present invention relates to a locking system according to the introductory part of claim 1.

The invention further relates to a fastening element in the form of a nut or a bolt according to the introductory part of claim 11 or 12, respectively.

### BACKGROUND

Locking systems as well as fastening elements of substantially the kind identified above are previously known, wherein a washer for locking purposes has a central hole, a first side comprising a pattern of radially extending teeth and a second side comprising a pattern of radially extending cams, a washer being intended to be applied together with a corresponding washer, the cam pattern sides being intended to face and engage each other and the pattern of teeth sides being intended to engage a contact surface of a fastening element, e.g. a bolt head bottom surface or a nut bottom surface or a work piece surface or the like.

In such an arrangement the main cam surface inclination exceeds the pitch of the threads of the fastening element which causes a positive and efficient locking of the fastening element.

Prior art hexagonal nuts and hexagon-headed bolts have a maximum diametrical extension between two diametrically opposing corners and are intended for locking washers having an outer diameter corresponding to said maximum diametrical extension.

It is most important to use the available pattern of teeth as efficient as possible for engagement with the nut or bolt and for many applications it is also important to keep the maximum diametrical extension of the fastening system substantially within the maximum width of the hexagonal nut or the hexagonal bolt head and to extend, maximize, the surface under the nut/bolt head, which surface transfers the load through the washer arrangement to the workpiece or the like, these important features not being provided by prior art technique.

Thus, a main purpose of the present invention is to provide a locking system and a fastening element providing these important features.

### SUMMARY OF THE INVENTION

The purpose specified above is obtained by a locking system according to claim 1 and fastening elements according to claims 11 and 12.

Further advantages are offered in the dependent claims.

### BRIEF DESCRIPTION OF THE DRAWINGS

A better understanding of the present invention will be had upon the reference to the following detailed description when read in conjunction with the accompanying drawings, wherein like reference characters refer to like parts through-out the several views and in which;

FIG. 1 schematically shows a prior art locking system employing a locking washer unit comprising a pair of locking washers and illustrates the locking principle,

FIG. 2a-c schematically show a nut and washer arrangement according to a first embodiment of the present invention in a perspective view, a view perpendicular to the axial direction of the arrangement and an axial view from above in the perpendicular to the axial direction view, respectively,

FIG. 3a-c schematically show a nut for e.g. an arrangement according to FIG. 2 in two perspective views and an axial view, respectively,

FIG. 4a-d schematically show a nut according to a second embodiment of the present invention to be used with a locking washer unit comprising one washer as indicated in FIG. 4d, the nut being shown in two perspective views and an axial view,

FIGS. 5a and b schematically show in two perspective views a first embodiment of a bolt according to the present invention, the bolt head being shaped substantially corresponding to the nut according to FIG. 3,

FIGS. 6a and b schematically show in two perspective views a second embodiment of a bolt according to the present invention, the bolt head being shaped substantially corresponding to the nut according to FIG. 4.

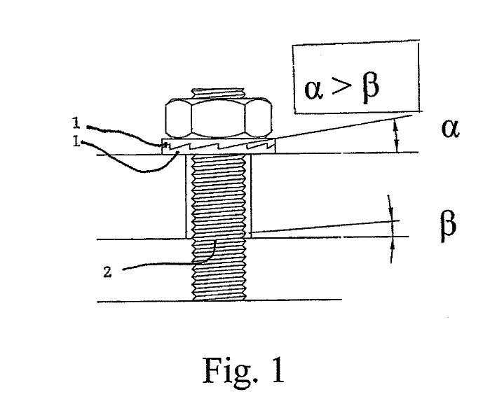

In FIG. 1, showing a prior art assembly, locking washers 1 are arranged in a pair for securing a bolt 2, as described above.

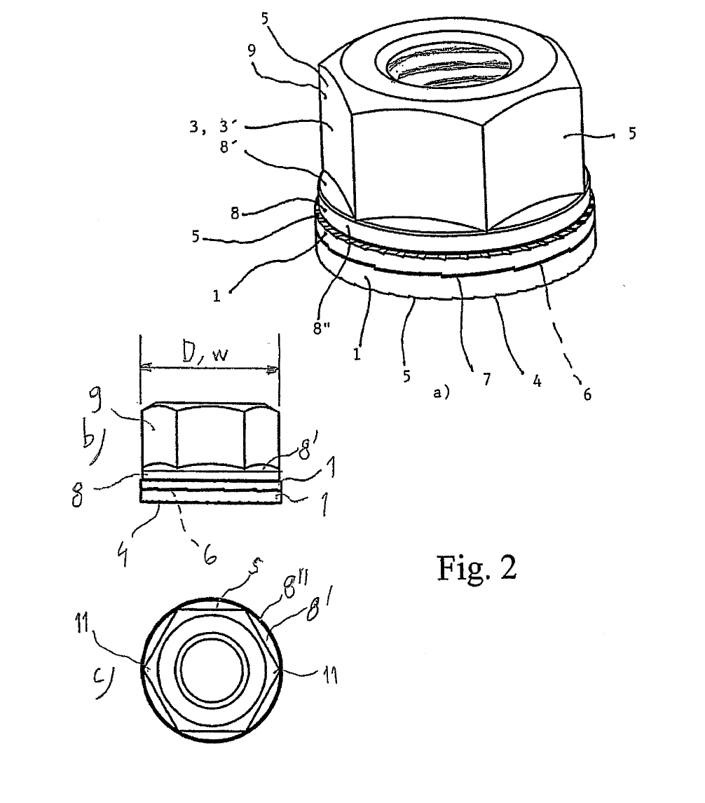

In FIG. 2 a fastening element 3 in the form of a nut 3′ according to the invention is arranged together with two washers 1 as part of a locking system, the nut being a hexagonal nut and each washer being of a substantially known kind having a central hole, not shown, a first side 4 comprising a pattern of radially extending teeth 5 and a second side 6 comprising a pattern of cams 7.

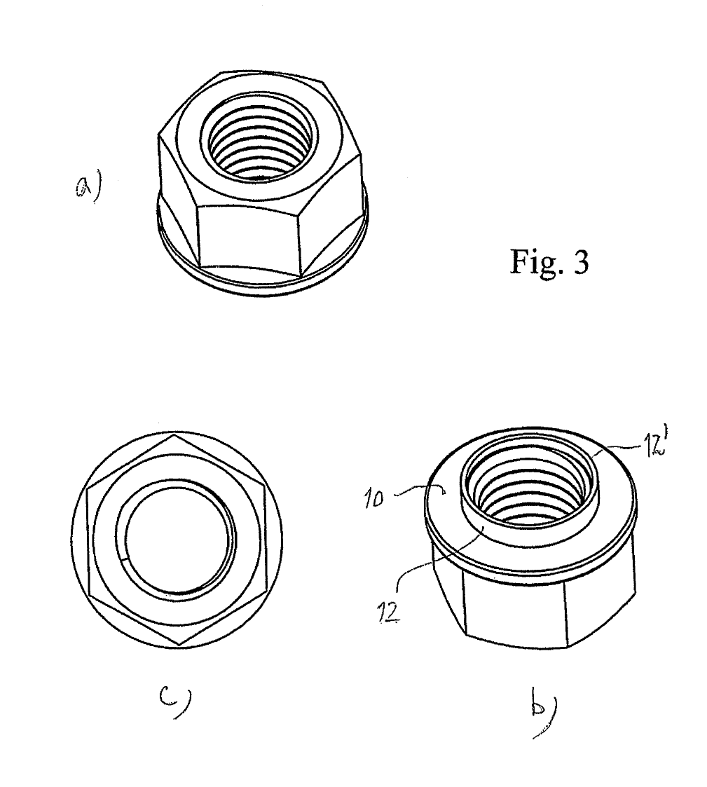

The fastening element 3, the nut 3′, comprises a contact portion 8 extending from the hexagonal part 9 of the fastening element and providing an annular end surface 10, FIG. 3b e.g., the contact portion having an outer diameter D substantially corresponding to the maximum width w of the hexagonal fastening element part, i.e. to the distance between two opposing corners 11, FIG. 2c.

According to sometimes preferred embodiments the diameter D slightly exceeds said width w.

According to preferred embodiments each transition portion 8′ between each side s of the hexagonal part of the fastening element according to the invention and the outer periphery 8″ of the contact portion 8 is slightly sloped towards the periphery for support and strength purposes.

According to embodiments of the kind shown in FIGS. 2 and 3 the annular end surface 10 of the fastening element is substantially flat, as shown in e.g. FIG. 3b, for engagement with a pattern of teeth 5 of a washer, in an arrangement with a pair of washers as shown e.g. in FIG. 2a.

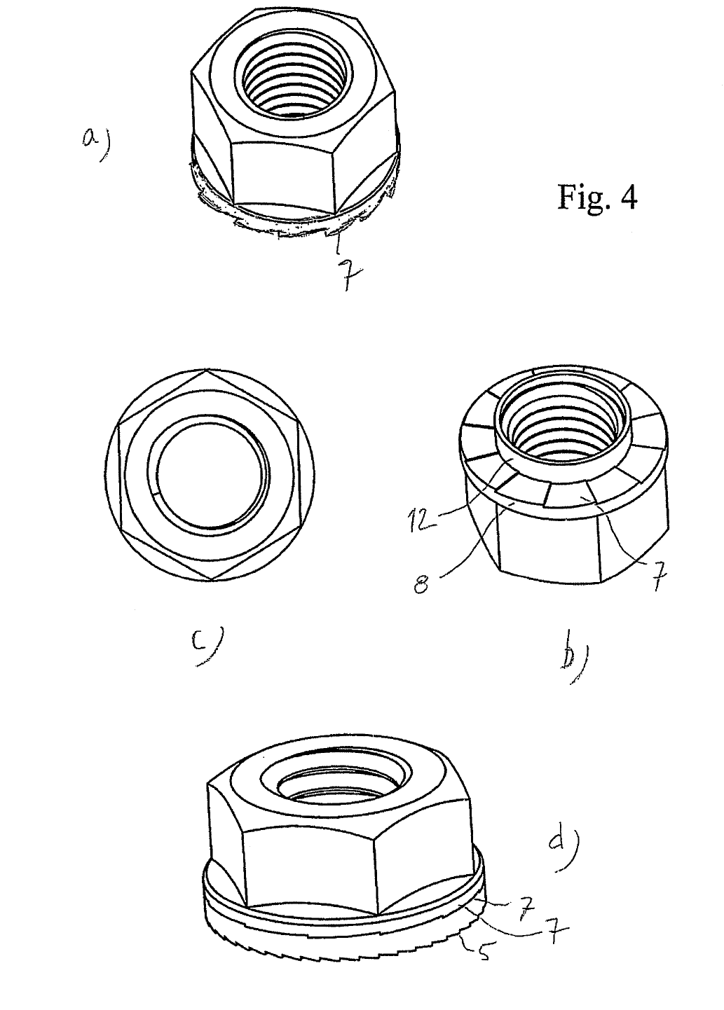

According to embodiments of the kind shown in FIG. 4 the annular end surface 10 comprises a pattern of cams 7 for engagement with a pattern of cams of a washer in an arrangement with one washer as shown in e.g. FIG. 4d.

According to sometimes preferred embodiments the nut has a guide collar 12 protruding form the contact portion end of the nut for guiding the washer or washers applied together with nut, the collar being shown in FIGS. 3b and 4b.

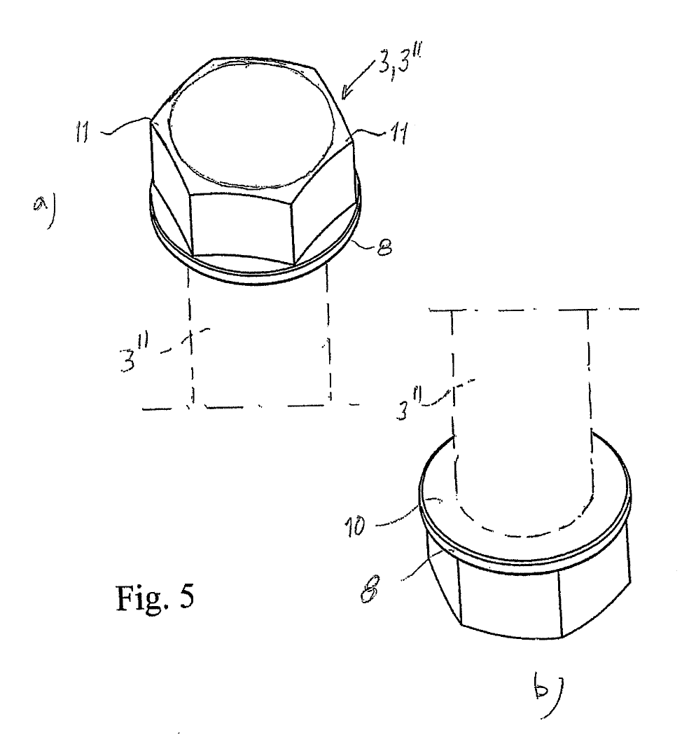

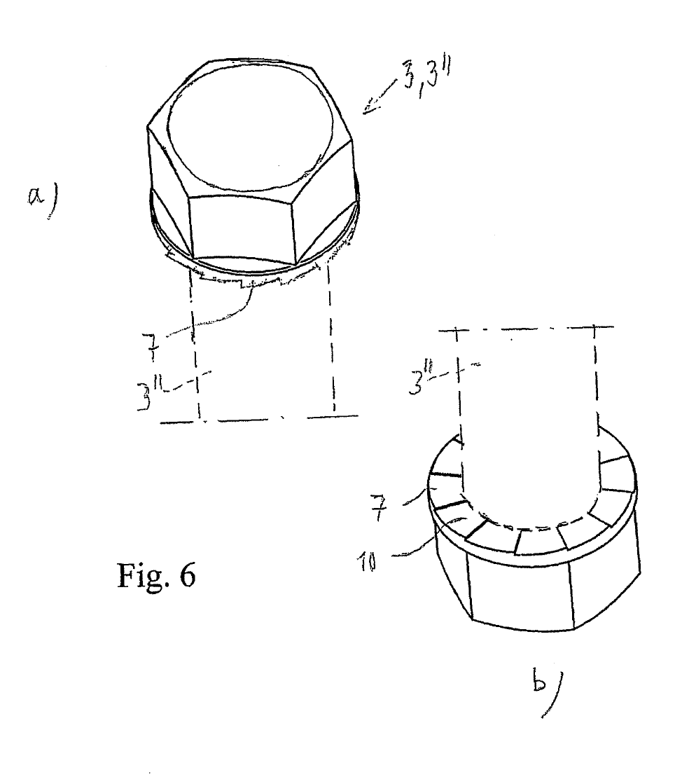

The fastening elements in the form of hexagon-headed bolts 3″, as shown in FIGS. 5 and 6, have a head shaped substantially as the corresponding nuts with respect to the circular contact portion 8 extending form the hexagonal part providing an annular end surface 10, the contact portion having an outer diameter D substantially corresponding to the maximum width w of the hexagon-head, i.e. to the distance between two opposing corners 11. As for the nut, sometimes preferred is that D slightly exceeds w.

In FIGS. 5 and 6 the threaded screw part 3″′ of the bolt 3″ is schematically shown by broken lines.

As in the nut case the end surface may be flat as in FIG. 5b for an arrangement comprising two washers or provided with a cam pattern as in FIG. 6b for an arrangement comprising just one washer, i.e. substantially congruent with what has been described for the corresponding nut arrangements.

According to sometimes preferred embodiments, not shown, the fastening element according to the invention is arranged together with one or two washers in an assembly in which the washer/-s is/are fastened, preferably still rotatable however, to the fastening element. In the nut case the guide collar 12 end part 12′, FIG. 3b, is expanded outwards to a flange-like configuration to hold one or two washers, the washer facing the expanded end part preferably having a bevel cutting at the central hole periphery. In the bolt case the thread of the bolt is roll formed after application of one or two washers, the threaded part diameter growing due to the formation of the thread so that the washer/-s is/are held and kept on the bolt between the thread and the bolt head.

The function of the locking system and the fastening element according to the invention should to a considerable and sufficient extent have been made clear above.

Thus, by means of the protruding circular contact portion of the hexagonal parts an annular end surface is provided to substantially cover and engage a relevant side of a locking washer so that the washer side pattern, of teeth or of cams, is used as efficiently as possible. This is achieved without extending the space necessary for the hexagonal nut or hexagonal bolt head since the diameter of the protruding contact portion corresponds to the maximum diameter, width, of the respective hexagonal parts. Thus, the fastening system dimensions will not need more space than a prior art fastening system. Further the surface under the nut/bolt head is maximized for maximum load transfer through the washer/-s to the workpiece or the corresponding.

Further, the fastening elements according to the present invention may be manufactured in a way corresponding to, primarily, the way of ordinary hexagonal nuts and to a cost which is considerably lower than for ordinary flange nuts, which are manufactured from pieces of a bar in a die.

Above the invention has been described in association with examples and preferred embodiments.

Of course, further embodiments as well as minor changes and additions may be imagined without departing from the basic inventive idea.

Thus the height of the hexagonal element part may of course vary between different products, applications and use. Further the height, thickness, of the protruding contact portion may vary and be chosen considering the application and use.

Thus, the invention should not be considered limited to the embodiments shown that may be varied within the scope of the accompanying claims.

1. A locking system comprising a fastening element, the fastening element being a hexagonal nut or a hexagon-headed bolt, and a locking washer unit, a locking washer having a central hole, a first side comprising a pattern of radially extending teeth and a second side comprising a pattern of radially extending cams, wherein that the fastening element comprises a contact portion extending from the hexagonal part of the fastening element and providing an annular end surface of the hexagonal fastening element part, the contact portion having an outer diameter (D) substantially corresponding to the maximum width (w) of the hexagonal fastening element part.

2. A system according to claim 1, wherein the end surface is substantially flat for engagement with a pattern of teeth of a washer.

3. A system according to claim 1, wherein the end surface comprises a pattern of cams for engagement with a pattern of cams of a washer.

4. A system according to claim 1, wherein the fastening element is a nut having a washer guide collar protruding from the washer contact portion end of the nut.

5. A system according to claim 2, wherein the fastening element is used in combination with a pair of washers being applied with the cam pattern sides facing and engaging each other.

6. A system according to claim 3, wherein the fastening element is used in combination with one washer, the cam pattern of the end surface engaging the cam pattern side of the washer.

7. A system according to claim 1, wherein an assembly comprising a fastening element holding one or two locking washers is provided.

8. A system according to claim 7, wherein the fastening element is a nut having a washer guide collar protruding from the washer contact portion end of the nut,
the guide collar end portion being expanded outwards to a flange-like configuration to hold one or two washers.

9. A system according to claim 8, wherein the washer facing the expanded end part having a bevel cutting at the central hole periphery.

10. A system according to claim 7, wherein the fastening element is a bolt having a roll formed thread being formed after the application of one or two locking washers,
the threaded part diameter being expanded due to the formation of the thread so that the washer/-s is/are held and kept on the bolt between the thread and the bolt head.

11. A fastening element for a locking system characterized in that the fastening element is a nut according to claim 1.

12. A fastening element for a locking system, characterized in that the fastening element is a bolt according to claim 1.
